(19) United States
(12) Patent Application Publication
(10) Pub. No.: US 2024/0007403 A1
(43) Pub. Date: Jan. 4, 2024

(54) MACHINE LEARNING TECHNIQUES FOR IMPLEMENTING TREE-BASED NETWORK CONGESTION CONTROL

(71) Applicant: NVIDIA CORPORATION, Santa Clara, CA (US)

(72) Inventors: Gal CHECHIK, Tel Aviv (IL); Gal DALAL, Shimshit (IL); Benjamin FUHRER, Tel Aviv (IL); Doron HARITAN KAZAKOV, Jerusalem (IL); Shie MANNOR, Haifa (IL); Yuval SHPIGELMAN, Netanya (IL); Chen TESSLER, Zichron Yaakov (IL)

(21) Appl. No.: 18/298,949

(22) Filed: Apr. 11, 2023

Related U.S. Application Data
(60) Provisional application No. 63/356,795, filed on Jun. 29, 2022.

(51) Int. Cl. H04L 47/127; H04L 41/16

(52) U.S. Cl. CPC H04L 47/127; H04L 41/16

(57) ABSTRACT

In various embodiments, a congestion control modelling application automatically controls congestion in data transmission networks. The congestion control modelling application executes a trained neural network in conjunction with a simulated data transmission network to generate a training dataset. The trained neural network has been trained to control congestion in the simulated data transmission network. The congestion control modelling application generates a first trained decision tree model based on an initial loss for an initial model relative to the training dataset. The congestion control modelling application generates a final tree-based model based on the first trained decision tree model and at least a second trained decision tree model. The congestion control modelling application executes the final tree-based model in conjunction with a data transmission network to control congestion within the data transmission network.

### CROSS-REFERENCE TO RELATED APPLICATIONS

This application claims priority benefit of the United States Provisional Patent Application titled, “PRACTICAL REINFORCEMENT LEARNING CONGESTION CONTROL TECHNIQUES,” filed on Jun. 29, 2022 and having Ser. No. 63/356,795. The subject matter of this related application is hereby incorporated herein by reference.

### BACKGROUND

### Field of the Various Embodiments

The various embodiments relate generally to computer science, artificial intelligence, and computer networking and, more specifically, to machine learning techniques for implementing tree-based network congestion control.

### Description of the Related Art

Congestion within a data transmission network occurs when the rate at which traffic arrives at a connection point in the network exceeds the rate at which the connection point can process the traffic. In general, the overall performance of a network can be substantially degraded when congestion sets in. In an effort to prevent and/or mitigate congestion within networks, congestion control algorithms oftentimes are used to limit transmission rates within networks. Congestion control algorithms are typically implemented via rule-based heuristics that normally do not generalize well across different network topologies and traffic patterns. Accordingly, when implementing a congestion control algorithm for a particular network, a domain expert usually has to calibrate rule-based heuristics based on the network and a set of pre-determined traffic patterns. In practice, however, even domain experts usually struggle to comprehensively understand how different characteristics of a complex network interact and lead to congestion. Consequently, approaches that rely on rule-based heuristics oftentimes provide sub-optimal congestion control for complex networks.

To address the above problems, some more advanced approaches to network congestion control involve implementing reinforcement learning (RL) techniques to train neural networks to perform congestion control (CC) within simulated networks operating under wide ranges of emulated traffic patterns. During one or more simulations, an RL-CC algorithm independently controls the transmission rate of each one-way network flow in the simulated network at the sending device. The RL-CC algorithm repeatedly measures a round-trip time (RTT) for a network flow, uses a neural network to map a feature vector that includes the RTT to a rate modifier, and modifies the current transmission rate of the network flow based on the rate modifier. The RL-CC algorithm periodically modifies the neural network based on recorded data for all network flows within the simulated network to increase the overall performance of the simulated network. In this iterative fashion, the trained or RL-CC neural network can learn to detect and account for subtle correlations between transmission rates and overall performance of a given network.

One drawback of the use of RL-CC neural networks is that the relatively high computational complexity of RL-CC neural networks usually precludes using RL-CC neural networks to control congestion in remote direct memory access (RDMA) networks. In this regard, if the “inference time” that an RL-CC neural network takes to compute a rate modifier in response to a measurement of a given RTT is greater than the RTT in an equivalent, non-simulated real network, then the RL-CC neural network cannot effectively control congestion in the non-simulated, real network. With respect to RDMA networks, congestion control and other networking operations are typically offloaded from central processing units (CPUs) to processors that reside in network interface cards (NICs). The processors in NICs, though, are normally integer-only processors that have limited processing capabilities and memory. Accordingly, NIC processors are unable to effectively process the thousands of relatively complex operations that an RL-CC neural network usually executes to compute each rate modifier. As a result, the inference time of an RL-CC neural network when executed on a typical NIC processor is usually at least one order of magnitude larger than an RTT in a typical, real RDMA network. In this vein, empirical results have corroborated that RL-CC neural networks cannot effectively control congestion in most, if not all, RDMA networks.

As the foregoing illustrates, what is needed in the art are more effective techniques for controlling congestion in RDMA networks.

### SUMMARY

One embodiment sets forth a computer-implemented method for controlling congestion in data transmission networks. The method includes executing a first trained neural network in conjunction with a simulated data transmission network to generate a training dataset, where the first trained neural network has been trained to control congestion in the simulated data transmission network; generating a first trained decision tree model based on an initial loss for an initial model relative to the training dataset; generating a final tree-based model based on the first trained decision tree model and at least a second trained decision tree model; and executing the final tree-based model in conjunction with a first data transmission network to control congestion within the first data transmission network.

At least one technical advantage of the disclosed techniques relative to the prior art is that the disclosed techniques enable learned congestion control knowledge to be transferred from an RL-CC neural network to a computationally simpler trained tree-based model that can be effectively implemented in a remote direct memory access (RDMA) network, where a typical NIC processor is able to process the simpler integer comparison operations executed within the trained tree-based model when computing each rate modifier. Further, the disclosed techniques allow the number and depths of the trained decision tree models included in the trained tree-based model to be limited to ensure that the inference time of the trained tree-based model, when executed on a target NIC processor, is less than an RTT within a target RDMA network. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the model distillation engine of FIG. 1, according to various embodiments;

FIG. 3 is a flow diagram of method steps for training a tree-based model to control congestion in a data transmission network, according to various embodiments; and

FIG. 4 is a flow diagram of method steps for controlling congestion in a data transmission network, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

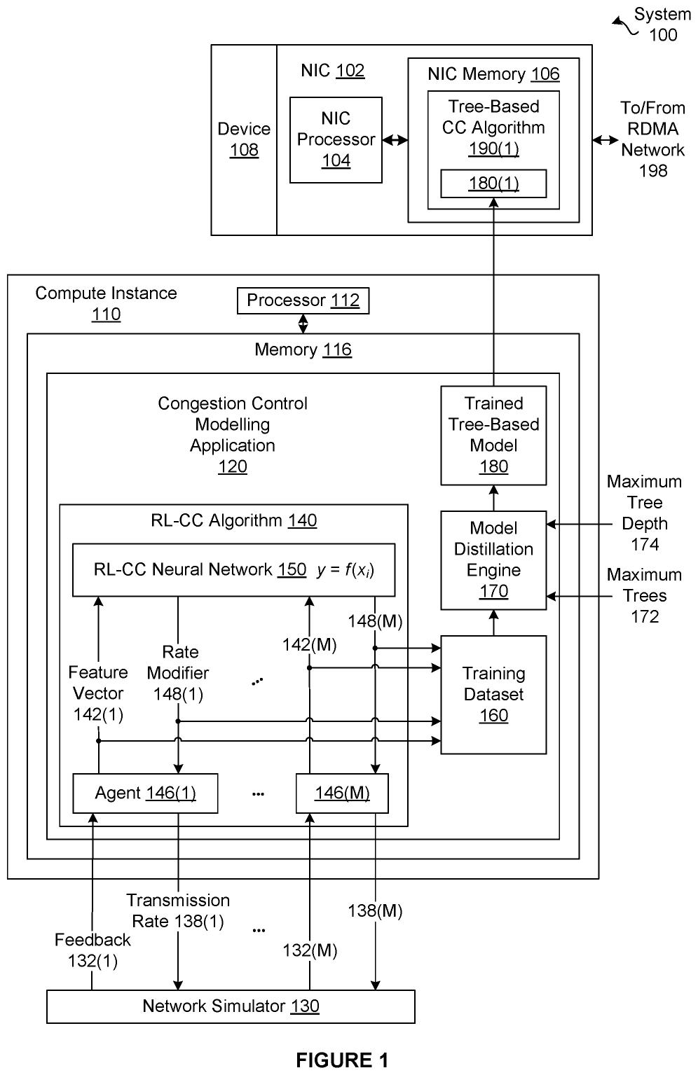

FIG. 1 is a conceptual illustration of a system 100 configured to implement one or more aspects of the various embodiments. As shown, in some embodiments, the system 100 includes, without limitation, a compute instance 110, a network simulator 130, a device 108, and a NIC 102. In some other embodiments, the system 100 can include any number and/or types of other compute instances, other network simulators, other NICs, other network interfaces, other devices, or any combination thereof.

Any number of the components of the system 100 can be distributed across multiple geographic locations or implemented in one or more cloud computing environments (e.g., encapsulated shared resources, software, data) in any combination. In some embodiments, the compute instance 110 and/or zero or more other compute instances can be implemented in a cloud computing environment, implemented as part of any other distributed computing environment, or implemented in a stand-alone fashion.

As shown, the compute instance 110 includes, without limitation, a processor 112 and a memory 116. In some embodiments, each of any number of other compute instances can include any number of other processors and any number of other memories in any combination. In particular, the compute instance 110 and/or one or more other compute instances can provide a multiprocessing environment in any technically feasible fashion.

The processor 112 can be any instruction execution system, apparatus, or device capable of executing instructions. For example, the processor 112 could comprise a central processing unit, a graphics processing unit, a controller, a microcontroller, a state machine, or any combination thereof. The memory 116 stores content, such as software applications and data, for use by the processor 112.

The memory 116 can be one or more of a readily available memory, such as random-access memory, read only memory, floppy disk, hard disk, or any other form of digital storage, local or remote. In some embodiments, a storage (not shown) may supplement or replace the memory 116. The storage may include any number and type of external memories that are accessible to the processor 112 of the compute instance 110. For example, and without limitation, the storage can include a Secure Digital Card, an external Flash memory, a portable compact disc read-only memory, an optical storage device, a magnetic storage device, or any suitable combination of the foregoing.

In some embodiments, the compute instance 110 can be integrated with any number and/or types of other devices (e.g., one or more other compute instances and/or a display device) into a user device. Some examples of user devices include, without limitation, desktop computers, laptops, smartphones, and tablets.

In general, the compute instance 110 is configured to implement one or more software applications. For explanatory purposes only, each software application is described as residing in the memory 116 of the compute instance 110 and executing on the processor 112 of the compute instance 110. In some embodiments, any number of instances of any number of software applications can reside in the memory 116 and any number of other memories associated with any number of other compute instances and execute on the processor 112 of the compute instance 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In particular, the compute instance 110 is configured to generate a model that can be executed in conjunction with a data transmission network to control congestion within the data transmission network. A data transmission network is also referred to herein as a network. As described previously herein, in one approach to network congestion control, RL techniques are used to train a neural network to perform congestion control within simulated networks. One drawback of the use of the resulting RL-CC neural network is that the relatively high computational complexity of the RL-CC neural network usually precludes implementing the RL-CC neural network in a NIC to control congestion in a real RDMA network. More specifically, because a inference time of an RL-CC neural network when executed on a typical NIC processor is usually at least one order of magnitude larger than an RTT in a typical, real RDMA network, the RL-CC neural network cannot effectively control congestion in the RDMA network.

### Transferring Congestion Control Knowledge from a Neural Network to a Tree-Based Model

To address the above problems, the system 100 includes, without limitation, a congestion control modelling application 120. As described in greater detail below, the congestion control modelling application 120 transfers congestion control knowledge from a trained neural network to a tree-based model to generate a trained tree based model. Notably, the computational complexity of the trained tree-based model is significantly lower than the computational complexity of the trained neural network. Further, the congestion control modelling application 120 can limit the computational complexity of the trained tree-based model to ensure that an inference time of the trained tree-based model when executed on a target processor does not exceed a maximum expected RTT within a target network.

Note that the techniques described herein are illustrative rather than restrictive and may be altered without departing from the broader spirit and scope of the invention. For instance, the congestion control modelling application 120 is depicted in and described in conjunction with FIG. 1 in the context of transferring congestion control knowledge from an RL-CC neural network 150 that is included in an RL-CC algorithm 140 to a tree-based model. The RL-CC neural network 150 is an exemplar RL-CC network and the RL-CC algorithm 140 is an exemplar RL-CC neural network. In some other embodiments, the RL-CC neural network 150 can be replaced with any number and/or types of RL-CC neural networks and/or the RL-CC algorithm 140 can be replaced with any number and/or types of other RL-CC algorithms, and the techniques described herein are modified accordingly.

As used herein, an “RL-CC neural network” refers to any trained neural network that encapsulates congestion control knowledge learned via any number and/or types of recursion-learning techniques. In some embodiments, an RL-CC network is trained to directly or indirectly control congestion in a simulated network and can be used to control congestion in any number and/or types of other simulated networks and/or non-simulated, real networks that have the same or similar topologies.

An “RL-CC algorithm” refers herein to any type of algorithm that uses an RL-CC neural network to determine how to directly or indirectly modulate a transmission rate for a network flow in order to control network congestion without directly observing any other network flows or the underlying network. The congestion control modelling application 120 can acquire (e.g., generate, receive, read from memory) an RL-CC algorithm and an RL-CC model in any technically feasible fashion.

As shown, the congestion control modelling application 120 resides in the memory 116 of the compute instance 110 and executes on the processor 112 of the compute instance 110. The congestion control modelling application 120 includes, without limitation, the RL-CC algorithm 140, a training dataset 160, a model distillation engine 170, and a trained tree-based model 180.

During a training phase, the RL-CC algorithm 140 trains an untrained version of the RL-CC neural network 150 to control congestion in a simulated network over any number and/or types of simulated traffic patterns. The RL-CC algorithm 140 can train the untrained version of the RL-CC neural network 150 using any number and/or types of reinforcement learning techniques based on any number and/or types of congestion control goals.

For instance, in some embodiments, the RL-CC algorithm 140 implements an overall congestion control goal of increasing network utilization and fairness between network flows in the simulated network while reducing packet latency and packet drops. In some other embodiments, the RL-CC algorithm 140 implements an overall congestion control goal of of achieving a target balance between network bandwidth and packet latency while reducing packet loss,

For explanatory purposes, FIG. 1 depicts the RL-CC algorithm 140 during a distillation phase that follows the training phase. During the distillation phase, the congestion control modelling application 120 executes the RL-CC algorithm 140 (and therefore the RL-CC neural network 150) in conjunction with a simulated network to generate the training dataset 160. As shown, the RL-CC neural network 150 implements a function that is denoted herein as f(x).

More generally, the congestion control modelling application 120 can execute any type of trained neural network that has been trained to control congestion in a simulated data transmission network in conjunction with the same or another simulated data transmission network to generate the training dataset 160.

The simulated network is provided by the network simulator 130. The network simulator 130 models behaviors and interactions between any number and/or types of hardware components and software applications interconnected via any number and/or types of network topologies to provide any number of simulated networks operating in any number of simulated environments.

During the distillation phase, the network simulator 130 enables and/or orchestrates concurrent interactions between the different network flows included in the simulated network and the RL-CC algorithm 140. For instance, in some embodiments, the network simulator 130 causes the network flows to concurrently interact in many-to-one, all-to-all, long-short, and optionally any number and/or other types of scenarios. In the same or other embodiments, the network simulator 130 provides the same simulated network, generates the same type of network traffic, orchestrates the same type of scenario, or any combination thereof during both the training phase and the distillation phase.

Advantageously, simulating a wide range of traffic patterns and interaction scenarios during the training phase can increase the likelihood that the RL-CC neural network 150 learns to generalize to new traffic patterns and interaction scenarios. And simulating a wide range of traffic patterns and interaction scenarios during the distillation phase can increase the effectiveness with which the congestion control modelling application 120 transfers learned knowledge from the RL-CC neural network 150 to a tree-based model to generate the trained tree-based model 180.

In some embodiments, the simulated network represents a relatively complex RDMA network that interconnects various devices within a datacenter. The datacenter provides shared access to software applications and data via the RDMA network. Various components within the target datacenter are connected to the RDMA network via different instances of one or more target NICs. In some embodiments, the simulated network represents an RDMA network 198. Any number and/or types of devices can be interconnected via the RDMA network 198. For explanatory purposes, FIG. 1 depicts a device 108 that is connected to the RDMA network 198 via a NIC 102.

As shown, the RL-CC algorithm 140 includes, without limitation, the RL-CC neural network 150 and an agent 146(1)-an agent 146(M), where M can be any positive integer. For explanatory purposes, the agent 146(1)—the agent 146(M) are also referred to herein individually as an “agent 146” and collectively as “agents 146” and “agents 146(1)-146(M).”

During the distillation phase, each of the agents 146 independently controls a transmission rate of a different network flow within the simulated network over a variety of simulated traffic patterns while the RL-CC algorithm 140 records inputs to and outputs of the RL-CC neural network 150 to generate the training dataset 160. Notably, the RL-CC algorithm 140 does not modify the RL-CC neural network 150 during the distillation phase.

As shown, the agents 146(1)-146(M) control a transmission rate 138(1)-a transmission rate 138(M), respectively, based on feedback 132(1)-feedback 132(M), respectively. More specifically, for an integer j from 1 through M, the agent 146(j) controls the transmission rate 138(j) of a j^{th} network flow in the simulated network based on the feedback 132(j) associated with the j^{th} network flow. Both the transmission rate 138(j) and the feedback 132(j) can vary over time. The feedback 132(j) can include, without limitation, any amount and/or types of data (e.g., measurements, statistics, predictions, estimations) associated with the j^{th} network flow.

For instance, in some embodiments, the feedback 132(j) includes, without limitation, at least one of a measured RTT of the j^{th} network flow, a measured latency associated with the j^{th} network flow, any other measurement indicating a speed associated with the j^{th} network flow, or a statistic associated with the j^{th} network flow.

The agent 146(j) can acquire the feedback 132(j) and control the transmission rate 138(j) in any technically feasible fashion. For instance, in some embodiments, the agent 146(j) periodically inserts an RTT packet into the j^{th} network flow to measure the RTT of the j^{th} network flow. After receiving feedback 132(j) indicating a corresponding measured RTT, the agent 146(j) optionally modulates the transmission rate 138(j) based on the measured RTT. Because the agent 146(j) periodically inserts a new RTT packet into the j^{th} network flow, the feedback 132(j) is a sequence of discrete feedback points that monitors the RTT of the j^{th} network flow over time.

To control congestion in the simulated network, the agents 146(1)-146(M) independently use the RL-CC neural network 150 to determine how to modulate the transmission rate 138(1)—the transmission rate 138(M), respectively based, at least in part, on the feedback 132(1)—the feedback 132(M), respectively. The RL-CC neural network 150 can map any number and/or types of features associated with a network flow to any type of modification, decision, and/or modifier associated with the network flow.

As shown, in some embodiments, the RL-CC neural network 150 implements a function that is denoted herein as “y=f(x),” where x can be any feature vector of any network flow and y can by any type of rate modifier for the same network flow. A feature vector of a network flow can include values for any number and/or types of features associated with a network flow. The function “y=f(x)” is also denoted herein as f(x) and f. Some examples of features that can be included in a feature vector are a delay measurement (e.g., an RTT), a latency measurement, a transmission rate, and a statistic associated with a network flow.

In some embodiments, the feature vector includes, without limitation, a current transmission rate, a current feedback point, Z previous transmission rates, Z previous feedback points, and Z previous rate modifiers, where Z can be any positive integer (e.g., three). In the same or other embodiments, the rate modifier can be any multiplier, where the transmission rate of the associated network flow is to be set equal to the product of the multiplier and the current transmission rate. Accordingly, unless the rate modifier is equal to one, then the rate modifier indicates that the transmission rate of the associated network flow is to be modified in order to control network congestion.

As shown, a feature vector 142(1)-a feature vector 142(M) are feature vectors associated with 1^{st}-M^{th} network flows, respectively. The feature vector 142(1)—the feature vector 142(M) are individually generated, stored, and updated over time by the agents 146(1)-146(M), respectively. In a complementary fashion, a rate modifier 148(1)-rate modifier 148(M) are rate modifiers for the 1^{st}-M^{th} network flows, respectively, that are generated by the RL-CC neural network 150 based on the feature vector 142(1)—the feature vector 142(M), respectively.

For an integer j from 1 through M, upon receiving a new feedback point via the feedback 132(j), the agent 146(j) updates the feature vector 142(j). The agent 146(j) then executes the RL-CC neural network 150 on the feature vector 142((j) to compute (or re-compute) the rate modifier 148(M). Subsequently, the agent 146(j) sets the transmission rate 138(j) equal to the product of the current transmission rate and the rate modifier 148(j).

In some other embodiments, an RL-CC neural network can map a feature vector associated with a network flow to any type of modification that is to be made to the network flow. An agent executes the RL-CC neural network on a feature vector associated with a network flow to generate a modification that is to be made to the network flow. The agent then modifies the network flow based on the modification. For instance, in some embodiments, the agent modifies a transmission rate of the network flow in accordance with the modification.

More generally, in various embodiments, an RL-CC neural network can map a feature vector that includes, without limitation, any number and/or types of congestion indicators to any type of modification that is to be made to a network flow. Some examples of congestion indicators are a current transmission rate, a previous transmission rate, a previous modification, a switch output queue length, a switch output port utilization, and a number of congestion notification packets that have arrived since the last transmission rate update. As used herein, a switch output queue length refers to the amount of data in a switch buffer that is to transmit from the same port as data associated with the network flow. A switch output port utilization refers herein to a current bandwidth used for the switch output port of the network flow divided by the total port bandwidth for the switch output port of the network flow. A congestion notification packet is part of a mechanism provided by the Explicit Congestion Notification protocol that allows two end-points to exchange end-to-end notification of network congestion.

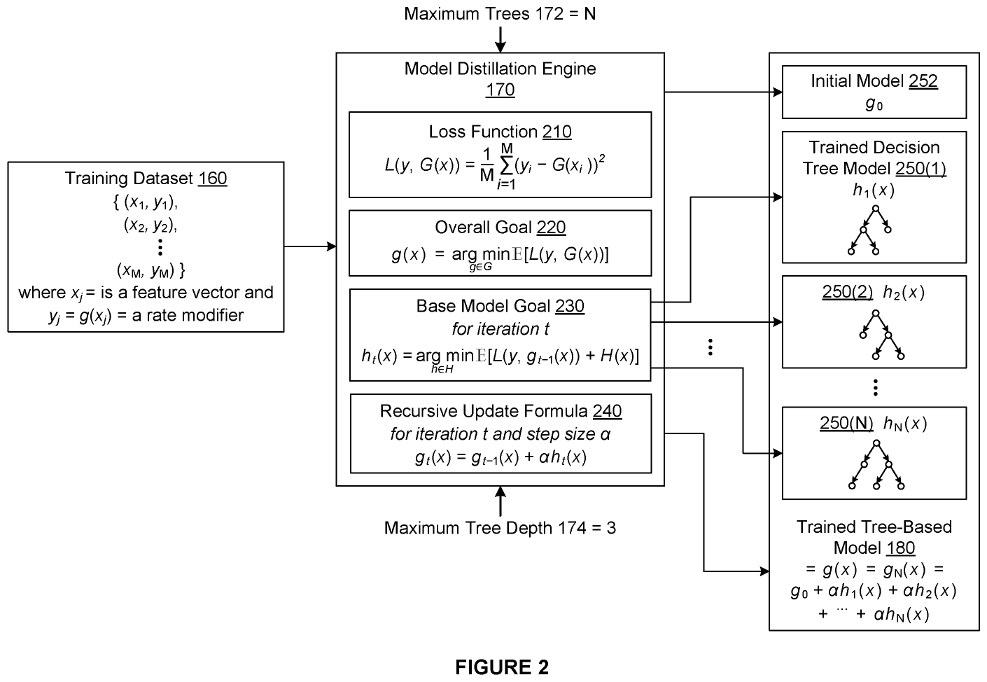

As described in greater detail below in conjunction with FIG. 2, the training dataset 160 includes, without limitation, any number of mappings performed by the RL-CC neural network 150 recorded during the distillation phase. Each mapping is from a feature vector for a network flow included in the simulated network to a modification to be made to the same network flow. Different mappings can be associated with different network flows. As described in greater detail below in conjunction with FIG. 2, in some embodiments, each mapping or training datapoint includes an RTT for a network flow and a rate modifier for the same network flow.

As shown, in some embodiments, the model distillation engine 170 generates the trained tree-based model 180 based on the training dataset 160, a maximum trees 172, and a maximum tree depth 174. The model distillation engine 170 can implement any number and/or types of machine learning algorithms and/or operations to train any type of tree-based model that complies with the maximum trees 172 and the maximum tree depth 174 based on the training dataset 160.

The maximum trees 172 specifies an upper limit on a total number of trained trees included in the trained tree-based model 180. The maximum tree depth 174 specifies an upper limit on the depth of each trained tree included in the trained tree-based model 180. In some embodiments, the maximum trees 172 and the maximum tree depth 174 are selected to ensure that the inference time of the trained tree-based model 180, when executed on a NIC processor 104 included in the NIC 102, is less than an RTT within the RDMA network 198.

As described in greater detail below in conjunction with FIG. 2, in some embodiments, the model distillation engine 170 uses gradient boosting to iteratively generate and add weighted trained Classification and Regression Tree (CART) models to an initial model to generate the trained tree-based model 180. More specifically, the model distillation engine 170 iteratively constructs a linear combination of trained decision tree models based on the training dataset 160 to generate the trained tree-based model 180. Notably, a final loss for the trained tree-based model 180 relative to the training dataset 160 is less than an initial loss for the initial model relative to the training dataset 180.

Notably, because the training dataset 160 represents congestion control knowledge learned by the RL-CC neural network 150, the model distillation engine 170 transfers congestion control knowledge from the RL-CC neural network 150 to the tree-based model to generate the trained tree-based model 180. The trained tree-based model 180 can be used to control congestion in any number and/or types of simulated networks and/or non-simulated, real networks that have the same or similar topologies to the simulated network(s) used to train the RL-CC neural network 150 and/or generate the training dataset 160.

In some embodiments, the congestion control modelling application 120 generates a tree-based CC algorithm that uses the trained tree-based model 180 to determine how to directly or indirectly update a network flow in order to control network congestion without directly observing any other network flows or the underlying network. The congestion control modelling application 120 can acquire (e.g., generate, receive, read from memory) the tree-based CC algorithm in any technically feasible fashion. In some embodiments, the congestion control modelling application 120 replaces the RL-CC neural network 150 in the RL-CC algorithm with the trained tree-based model 180 to generate the tree-based CC algorithm.

In some embodiments, the congestion control modelling application 120 stores the trained tree-based model 180 and/or the tree-based CC algorithm in any number and/or types of memories. In the same or other embodiments, the congestion control modeling application 120 transmits the trained tree-based model 180 and/or the tree-based CC algorithm to any number and/or types of devices and/or any number and/or types of software applications.

The congestion control modelling application 120 and/or any other software application can execute the trained tree-based model 180 in conjunction with any number and/or types of networks to control congestion within the network(s). In operation, for each of any number of network flows in a data transmission network, a different agent controls a different network flow at a sending device or at an interface to the sending device. Each agent uses the trained tree-based model 180 to determine how to modify the associated network flow in order to control congestion in the data transmission network.

In some embodiments, the trained tree-based model 180 transmits a different instance if a tree-based CC algorithm that includes the trained tree-based model 180 to each of the NIC 102 and optionally any number of other NICs, other network interfaces, or devices that are connected to the RDMA network 198. The NIC 102 connects the device the 108 to the RDMA network 198 and includes, without limitation, the NIC processor 104 and the NIC memory 106.

As shown, a tree-based CC algorithm 190(1) resides in the NIC memory 106 and includes a trained tree-based model 180(1). The tree-based CC algorithm 190(1) is an instance of a tree-based CC algorithm. The trained tree-based model 180(1) is an instance of the trained tree-based model 180. The NIC processor 104 executes the tree-based CC algorithm 190(1) and therefore the trained tree-based model 180(1) in order to control at least one transmission rate of at least one network flow included in the RDMA network 198 in order to control congestion within the RDMA network 198.

In operation, each of one or more agents (not shown) included in the tree-based CC algorithm 190(1) uses the trained tree-based model 180(1) to control congestion for a different network flow for which the device 108 is the sending device. When an agent receives feedback for the associated network flow in the RDMA network 108, the agent generates a feature vector based on the feedback. The agent computes, via the trained tree-based model 180(1), a modification to be made to the associated network flow based on the feature vector. The agent then modifies the associated network flow based on the modification.

Note that the techniques described herein are illustrative rather than restrictive and may be altered without departing from the broader spirit and scope of the invention. Many modifications and variations on the functionality provided by the congestion control modelling application 120, the RL-CC algorithm 140, the RL-CC neural network 150, the agent 146(1)—the agent 146(M), the model distillation engine 170, the trained tree-based model 180, the tree-based CC algorithm 190, and the network simulator 130 will be apparent to those of ordinary skill in the art without departing from the scope and spirit of the described embodiments. In some embodiments, the inventive concepts described herein in the context of the dialogue matching application 120 can be practiced without any of the other inventive concepts described herein.

It will be appreciated that the system 100 shown herein is illustrative and that variations and modifications are possible. For instance, the connection topology between the various components in FIG. 1 may be modified as desired. Further, the number and/or types of components in FIG. 1 may be modified as desired. For instance, in some embodiments, the functionality of the RL-CC algorithm 140 is replaced with N different instances of a per-agent RL CC algorithm that uses the RL-CC neural network 150.

### Training a Tree-Based Model to Mimic a Trained Neural Network

FIG. 2 is a more detailed illustration of the model distillation engine 170 of FIG. 1, according to various embodiments. As shown, the model distillation engine 170 generates the trained tree-based model 180 based on the training dataset 160, the maximum trees 172, and the maximum tree depth 174. The model distillation engine 170 depicted in FIG. 2 is an exemplar model distillation engine that uses gradient boosting to iteratively generate and add weighted trained CART models to an initial model 252 to generate the trained tree-based model 180.

In the context of gradient boosting, the trained tree-based model 180 depicted in FIG. 2 is also referred to as an “ensemble model” and a CART model is also referred to as a “base learner model.” Gradient boosting and, more generally, boosting are types of machine learning techniques that are well-known in the art. Please see https://en.wikipedia.org/wiki/Gradient_boosting and https://en.wikipedia.org/wiki/Boosting_(machine_learning).

As used herein, a “CART model” refers to a machine learning model that can be generated or trained using a CART algorithm. The resulting trained CART model can be represented as a binary decision tree. Techniques for generating trained CART models and, more generally, for decision tree learning are well-known in the art. Please see https://machinelearningmastery.com/classification-and-regression-trees-for-machine-learning/ and https://en.wikipedia.org/wiki/Decision_tree_learning.

In some other embodiments, the model distillation engine 170 can implement any number and/or types of boosting algorithms and/or operations and use any number and/or types of base learner models that can be represented as decision trees to construct a trained tree-based model based on the training dataset 160. In the same or other embodiments, the model distillation engine 170 can implement any number and/or types of machine learning algorithms and/or operations to train any number and/or types of base learner models that can be represented as decision trees.

As shown, in some embodiments, the training dataset 160 includes, without limitation, M training datapoints, where M can be any positive integer. Each training datapoint specifies a mapping from a feature vector to a rate modifier as per the RL-CC neural network 150. The rate modifiers included in the training dataset 160 are also referred to herein collectively as “predicted outputs” and individually as a “predicted output.” As shown, the training dataset 160 is denoted as {(x₁, y₁), (x₂, y₂), . . . , (x_{M}, y_{M})}. For an integer j from 1 to M, the p training data point is denoted as (xⱼ, yⱼ), where xⱼ denotes a feature vector, f(x) denotes a mapping function implemented by the RL-CC neural network 150, and and yᵢ denotes a rate modifier that is equal to f(xⱼ).

Accordingly, as the model distillation engine 170 fits the tree-based model to the training dataset 160, the model distillation engine 170 trains the tree-based model to approximate the behavior of the RL-CC neural network 150. After the model distillation engine 170 determines that the training of the tree-based model is complete, the model distillation engine 170 designates the final version of the tree-based model as the trained tree-based model 180.

The maximum trees 172 specifies an upper limit on a total number of trained CARTs that the model distillation engine 170 generates. The maximum tree depth 174 or “maximum depth” specifies an upper limit on the depth of each trained CART that the model distillation engine 170 generates. As persons skilled in the art will recognize, the combination of the maximum trees 172 and the maximum tree depth 174 indirectly imposes an upper limit on the number of operations that the trained tree-based model 180 executes to map a feature vector to a rate modifier and therefore an inference time of the trained tree-based model 180.

The maximum trees 172 and the maximum tree depth 174 can be selected in any technically feasible fashion. In some embodiments, the maximum trees 172 and the maximum tree depth 174 are selected such that the inference time of the trained tree-based model 180 when executed on the NIC processor 104 is less than a maximum RTT in the RDMA network 198. For explanatory purposes, FIG. 2 illustrates exemplary values of N for the maximum trees 172 and three for the maximum tree depth 174, where N can be any positive integer.

In some embodiments, when training the tree-based model, the model distillation engine 170 iteratively adds trained decision tree models to the tree-based model until the model distillation engine 170 determines that a total number of trained decision tree models included in the tree-based model is equal to the maximum trees 172. The model distillation engine 170 then designates the most recent version of the tree-based model as the trained tree-based model 180. In the same or other embodiments, the model distillation engine 170 iteratively trains a decision tree model until the model distillation engine 170 determines that the depth of the decision tree model is equal to the maximum tree depth 174. The model distillation engine 170 then designates the most recent version of the decision tree model as a trained decision tree model.

The model distillation engine 170 depicted in FIG. 2 uses CART models having the maximum tree depth 174 as base learner models and determines that the training of a tree-based model is complete after the model distillation engine 170 has executed N “gradient boosting” iterations to generate N different trained base learner models. Note that the techniques described herein are illustrative rather than restrictive and may be altered without departing from the broader spirit and scope of the invention.

For instance, in some other embodiments, any type(s) of base learner models that can be represented as decision trees are used instead of or in addition to CART models. In the same or other embodiments, the model distillation engine 170 can determine that the training of a decision tree model and/or a tree-based model is complete in any technically feasible fashion based on any number and/or types of criteria (e.g., a target maximum loss) in addition to or instead of the maximum tree depth 174 and/or the maximum trees 172.

As shown, the trained tree-based model 180 implements a function that is denoted herein as g(x) and includes, without limitation, the initial model 252 and a trained decision tree model 250(1)-a trained decision tree model 250(N). The function g(x) approximates the function f(x) implemented by the RL-CC neural network 150. The trained decision tree model 250(1)—the trained decision tree model 250(N) are also referred to herein individually as a “trained decision tree model 250.” As described in greater detail below, the trained decision tree model 250(1)—the trained decision tree model 250(N) are trained CART models that implement different functions denoted herein as hₒ(x)-h_{N}(x), respectively.

Prior to executing the boosting iterations on the tree-based model, the model distillation engine 170 generates the initial model 252 and designates the initial model 252 as an initial starting point of a resulting tree-based model. The initial model 252 (i.e., the initial starting point of the resulting tree-based model) implements an initial function that is denoted herein as go. The model distillation engine 170 can generate the initial model 252 in any technically feasible fashion. In some embodiments, the model distillation engine 170 sets the initial model 252 equal to a constant value that is the average of the rate modifiers (y₁−y_{M}) included in the training dataset 160. The initial model 252 therefore implements a constant initial function go.

As shown, the model distillation engine 170 implements a loss function 210, an overall goal 220, a base model goal 230, and a recursive update formula 240. The loss function 210 measures an error or loss associated with the fit of a function denoted as G(x) to the training dataset 160. Consequently, as the loss decreases, the accuracy with which G(x) mimics the RL-CC neural network 150 over or relative to the training dataset 160 increases. In some embodiments, the loss function 210 is denoted as L(y, G(x)) and can be expressed as follows:

$$L ( y , G ( x ) ) = \frac{1}{M} {\sum }_{i = 1}^{M} {( {y}_{i} - G ( {x}_{i} ) )}^{2} \qquad ( 1 )$$

The overall goal 220 is a training goal of the model distillation engine 170 that aligns with the general goal of the congestion control modelling application 120. As described previously herein in conjunction with FIG. 1, the general goal of the congestion control modelling application 120 is to distill the RL-CC neural network 150 into a significantly simpler tree-based model. The overall goal 220 of the model distillation engine 170 is to generate the trained tree-based model 180 such that a loss for the function g(x) relative to the training dataset 160 is minimized. A loss associated with the fit of a function or a model to the training dataset 160 is also referred to herein as a loss for the function or the model relative to the training dataset 160.

More specifically, the overall goal 220 is to minimize the loss function 210 in expectation over or relative to the training dataset 160. As shown, in some embodiments, the overall goal 220 can be expressed mathematically as follows:

$$g ( x ) = {arg min}_{g ∈ G} E [ L ( y , G ( x ) ) ] \qquad ( 2 )$$

During each gradient boosting iteration, the model distillation engine 170 modifies a current version the tree-based model that is associated with a loss over or relative to the training dataset 160 to generate a new version of the tree-based model that is associated with a reduced loss over or relative to the training dataset 160. More precisely, during a t^{th} gradient boosting iteration, where 1<=t<=N, the model distillation engine 170 generates a new version of the tree-based model that implements a function that is denoted herein as gₜ(x), where L(y, gₜ(x)<L(y, gₜ₋₁(x).

During the t^{th} boosting iteration, where 1<=t<=N, the model distillation engine 170 trains a decision tree model to predict the negative gradient of the loss function 210 with respect to predicted rate modifiers gₜ₋₁(x₁)-gₜ₋₁(x_{M}). The resulting trained decision tree model 250(t) implements the function hₜ(x) in accordance with the base model goal 230 that can be expressed as follows:

$${h}_{t} ( x ) = {arg min}_{h ∈ H} E [ L ( y , {g}_{t - 1} ( {x}_{1} ) + H ( x ) ) ] \qquad ( 3 )$$

In particular, during the 1st boosting iteration, the model distillation engine 170 generates the trained decision tree model 250(1) based on an initial loss for the initial model 252 relative to the training dataset 160. And over the 2^{nd}-N^{th} boosting iterations, the distillation engine 170 incrementally generates the trained tree-based model 180 such that the trained tree-based mode 180 is ultimately generated based on the trained decision tree model 250(1)—the trained decision tree model 250(N).

The model distillation engine 170 can implement any number and/or types of machine learning techniques (e.g., algorithms, operations) to train a decision tree model to implement the function hₜ(x). For instance, in some embodiments, the model distillation engine 170 uses the trained decision tree model 250(t−1) to map the feature vectors x₁-x_{M} specified in the training dataset 160 to the predicted rate modifiers gₜ₋₁(x₁)-gₜ₋₁(x_{M}). The predicted rate modifiers gₜ₋₁(x₁)−gₜ₋₁(x_{M}) are examples of predicted outputs. The model distillation engine 170 then executes a CART algorithm on a binary decision tree model based on a t^{th} “base” training dataset that can be expressed as {(x₁, y₁-gₜ₋₁(x₁)), (x₂, y₂-gₜ₋₁(x₂)), . . . , (x_{M}, y_{M}-gₜ₋₁(x_{M}))} to generate the trained decision tree model 250(t).

After generating the trained decision tree model 250(t), the model distillation engine 170 generates a new version of the tree-based model based on the current version of the tree-based model and the trained decision tree model 250(t). More precisely, the model distillation engine 170 weights the trained decision tree model 250(t) by a step size that is denoted herein as α and adds the trained decision tree model 250(t) to the current version of the tree-based model to generate a new version of the tree-based model that implements the function gₜ(x). The function gₜ(x) can be expressed mathematically using the recursive update formula 240 as follows:

gₜ(x)=gₜ₋₁(x)+αhₜ(x) (4)

In some other embodiments, the model distillation engine 170 can determine a different step size for each trained decision tree model 250 in any technically feasible fashion, and the recursive update formula 240 is modified accordingly.

As persons skilled in the art will recognize, the model distillation engine 170 increases the accuracy with which the tree-based model emulates the RL-CC neural network 150 over the training dataset 160 during each successive gradient boosting iteration. After executing the final gradient boosting iteration, the model distillation engine 170 designates the final version of the tree-based model or “final tree-based model” as the trained tree-based model 180. And because the final version of the tree-based model implements the function g_{N}(x), the function g(x) is equal to g_{N}(x). In this fashion, the model distillation engine 170 transfers the congestion control knowledge learned by the RL-CC neural network 150 to the trained tree-based model 180.

Advantageously, the trained tree-based model 180 can accurately emulate the RL-CC neural network 150 using significantly fewer and simpler operations. More specifically, because the trained tree-based model 180 is represented via a relatively simple if-else logical structure, the trained tree-based model 180 executes relatively simple integer comparison operations to compute each rate modifier. And the maximum trees 172 and the maximum tree depth 174 can be constrained to ensure that the number of operations that the trained tree-based model 180 executes to map a feature vector to a rate modifier does not exceeds a relatively small maximum number of operations (e.g., one hundred and fifty operations). Notably, the maximum number of operations can be selected such that the inference time of the trained tree-based model 180, when executed on a target NIC (e.g., the NIC processor 104), is less than an RTT in a target data transmission network (e.g., the RDMA network 198).

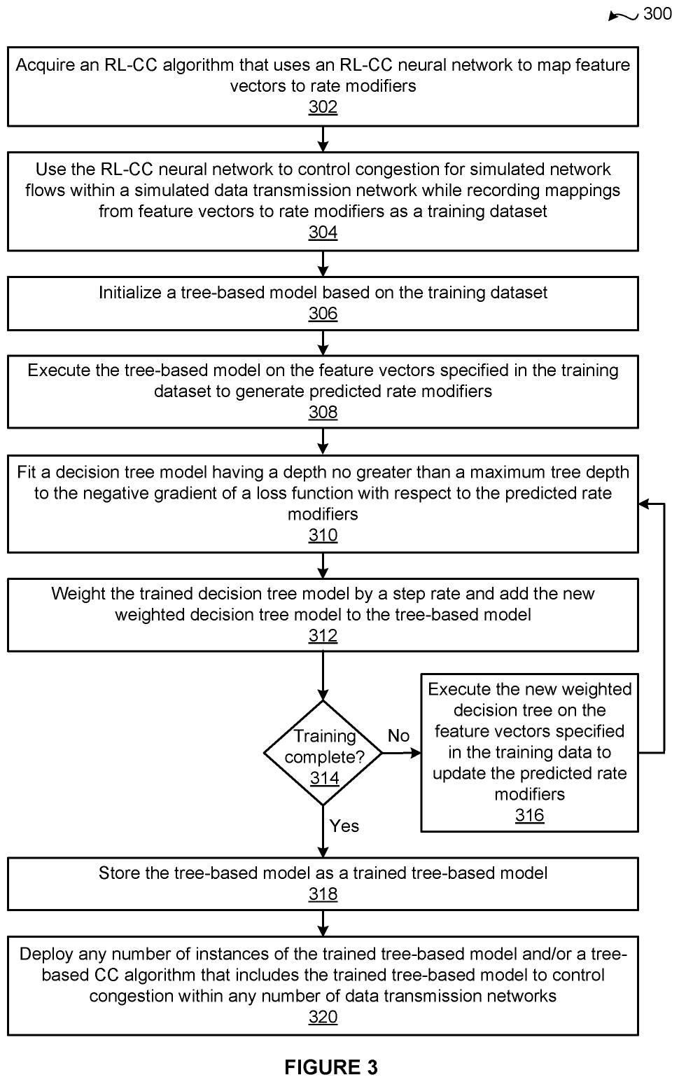

FIG. 3 is a flow diagram of method steps for training a tree-based model to control congestion in a data transmission network, according to various embodiments. Although the method steps are described with reference to the systems of FIGS. 1-2, persons skilled in the art will understand that any system configured to implement the method steps, in any order, falls within the scope of the embodiments.

As shown, a method 300 begins at step 302, where the congestion control modelling application 120 acquires an RL-CC algorithm that uses an RL-CC neural network 150 to map feature vectors to rate modifiers. At step 304, the congestion control modelling application 120 uses the RL-CC neural network 150 to control congestion for simulated network flows within a simulated data transmission network while recording mappings from feature vectors to rate modifiers as training dataset 160.

At step 306, the model distillation engine 170 initializes a tree-based model based on the training dataset 160. At step 308, the model distillation engine 170 executes the tree-based model on the feature vectors specified in the training dataset to generate predicted rate modifiers. At step 310, the model distillation engine 170 fits a decision tree model having a depth no greater than a maximum tree depth to the negative gradient of a loss function with respect to the predicted rate modifiers. At step 312, the model distillation engine 170 weights the trained decision tree model by a step rate and adds the new weighted decision tree model to the tree-based model.

At step 314, the model distillation engine 170 determines whether the training of the tree-based model is complete. If, at step 314, the model distillation engine 170 determines that the training of the tree-based model is complete, then the method 300 proceeds directly to step 316.

If, however, at step 314, the model distillation engine 170 determines that the training of the tree-based model is not complete, then the method 300 proceeds to step 316. At step 316, the model distillation engine 170 executes the new weighted decision tree on the feature vectors specified in the training data to update the predicted rate modifiers. The method 300 then returns to step 310, where the model distillation engine 170 fits a new decision tree model having a depth no greater than a maximum tree depth to the negative gradient of a loss function with respect to the updated predicted rate modifiers.

At step 318, the model distillation engine 170 stores the tree-based model as the trained tree-based model 180. At step 320, the congestion control modelling application 120 deploys any number of instances of the trained tree-based model 180 and/or a tree-based CC algorithm 190 that includes the trained tree-based model 180 to control congestion within any number of data transmission networks. The method 300 then terminates.

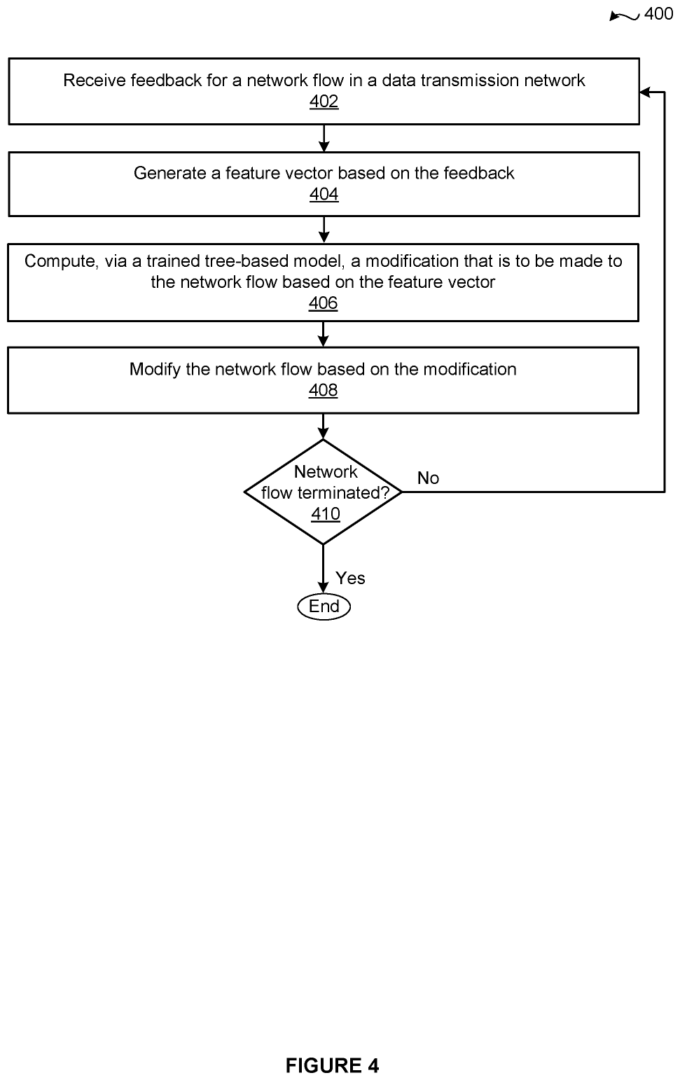

FIG. 4 is a flow diagram of method steps for controlling congestion in a data transmission network, according to various embodiments. Although the method steps are described with reference to the systems of FIGS. 1-2, persons skilled in the art will understand that any system configured to implement the method steps, in any order, falls within the scope of the embodiments. As persons skilled in the art will recognize, for each network flow in a data transmission network the method steps in FIG. 4 can be independently executed by a different agent at an associated sending device or at a network interface (e.g., a NIC) that connects the sending device to the data transmission network to control congestion in the data transmission network.

As shown, a method 400 begins at step 402, where an agent receives feedback for a network flow in a data transmission network. At step 404, the agent generates a feature vector based on the feedback. At step 406, the agent computes, via the trained tree-based model 180, a modification that is to be made to the network flow based on the feature vector. At step 408, the agent modifies the network flow based on the modification.

At step 410, the agent determines whether network flow has been terminated. If, at step 410, the agent determines that the network flow has not been terminated, then the method 400 returns to step 402, where the agent receives new feedback for the network flow.

If, however, at step 410, the agent determines that the network flow has been terminated, then the method 400 terminates.

In sum, the disclosed techniques can be used to automatically transfer congestion control knowledge from an RL-CC neural network to a computationally simpler, trained tree-based model. The RL-CC neural network is trained to map a feature vector for a network flow to a modification to be made to the network flow. In some embodiments, a congestion control modelling application includes an RL-CC algorithm and a model distillation engine. The congestion control modelling application executes the RL-CC algorithm n conjunction with a simulated data transmission network to generate a training dataset The RL-CC algorithm includes the RL-CC neural network and multiple agents. Each agent uses the RL-CC neural network to control the transmission rate of a different network flow in the simulated data transmission network. In operation, an agent periodically receives feedback (e.g., an RTT, a measured latency) for a network flow. The agent generates a feature vector based on the feedback and executes the RL-CC neural network on the feature vector to compute a modification to be made to the network flow. The agent then modifies the network flow based on the modification. As the agents execute the RL-CC neural network, the RL-CC algorithm records the mappings from feature vectors to modifications to generate the training dataset.

The model distillation engine generates the trained tree-based model based on the training dataset, a maximum trees, and a maximum tree depth. The maximum trees and the maximum tree depth limit the total number of trained trees and the depth of each trained tree that the model distillation engine uses to construct the trained tree-based model. The model distillation engine uses gradient boosting to iteratively fit a tree-based model to the training dataset, thereby generating a trained tree-based model that approximates the behavior of the RL-CC neural network. After initializing the tree-based model to an initial model based on the training dataset, the model distillation engine executes the tree-based model on the feature vectors included in the training dataset to compute predicted modifications. The model distillation engine then executes N boosting iterations, where N is equal to the maximum trees.

During each boosting iteration, the model distillation engine trains a CART model to predict a negative gradient of a loss function with respect to the predicted modifications to generate a trained CART model. Subsequently, the model distillation weights the trained CART model, adds the weighted trained CART model to the tree-based model, and updates the predicted modifications to reflect the weighted trained CART model. After the N^{th} iteration, the model distillation engine designates the most recently generated version of the tree-based model as a final or trained tree-based model.

At least one technical advantage of the disclosed techniques relative to the prior art is that the disclosed techniques enable learned congestion control knowledge to be transferred from an RL-CC neural network to a computationally simpler trained tree-based model that can be effectively implemented in a remote direct memory access (RDMA) network, where a typical NIC processor is able to process the simpler integer comparison operations executed within the trained tree-based model when computing each rate modifier. Further, the disclosed techniques allow the number and depths of the trained decision tree models included in the trained tree-based model to be limited to ensure that the inference time of the trained tree-based model, when executed on a target NIC processor, is less than an RTT within a target RDMA network. These technical advantages provide one or more technological improvements over prior art approaches.

1. In some embodiments, a computer-implemented method for controlling congestion in data transmission networks comprises executing a first trained neural network in conjunction with a simulated data transmission network to generate a training dataset, wherein the first trained neural network has been trained to control congestion in the simulated data transmission network; generating a first trained decision tree model based on an initial loss for an initial model relative to the training dataset; generating a final tree-based model based on the first trained decision tree model and at least a second trained decision tree model; and executing the final tree-based model in conjunction with a first data transmission network to control congestion within the first data transmission network.

2. The computer-implemented method of clause 1, wherein generating the final tree-based model comprises constructing a combination of the first trained decision tree model and the at least the second trained decision tree model.

3. The computer-implemented method of clauses 1 or 2, wherein generating the first trained decision tree model comprises executing the initial model on a plurality of feature vectors included in the training dataset to generate a plurality of predicted outputs; and training a decision tree model to predict a negative gradient of a loss function with respect to the plurality of predicted outputs.

4. The computer-implemented method of any of clauses 1-3, further comprising, while training the decision tree model, determining that a tree depth of the decision tree model is equal to a maximum tree depth; and designating the decision tree model as the first trained decision tree model.

5. The computer-implemented method of any of clauses 1-4, further comprising determining that a total number of trained decision tree models included in the final tree-based model is equal to a maximum number of trees; and designating the final tree-based model as a trained tree-based model.

6. The computer-implemented method of any of clauses 1-5, wherein the first data transmission network comprises a remote direct memory access network.

7. The computer-implemented method of any of clauses 1-6, wherein executing the final tree-based model in conjunction with the first data transmission network to control congestion comprises computing, via the final tree-based model, a first modification to be made to a network flow included in the first data transmission network based on at least one of a delay measurement, a latency measurement, or a transmission rate of the network flow; and modifying the network flow based on the first modification.

8. The computer-implemented method of any of clauses 1-7, wherein the training dataset includes a mapping from a first feature vector associated with a network flow included in the simulated data transmission network to a first modification to be made to the network flow.

9. The computer-implemented method of any of clauses 1-8, further comprising modifying a transmission rate of the network flow in accordance with the first modification.

10. The computer-implemented method of any of clauses 1-9, wherein the first feature vector comprises at least one of a delay measurement, a latency measurement, or a transmission rate associated with the network flow.

11. In some embodiments, one or more non-transitory computer readable media include instructions that, when executed by one or more processors, cause the one or more processors to automatically control congestion in data transmission networks by performing the steps of executing a first trained neural network in conjunction with a simulated data transmission network to generate a training dataset, wherein the first trained neural network has been trained to control congestion in the simulated data transmission network; generating a first trained decision tree model based on an initial loss for an initial model relative to the training dataset; generating a final tree-based model based on the first trained decision tree model and at least a second trained decision tree model; and executing the final tree-based model in conjunction with a first data transmission network to control congestion within the first data transmission network.

12. The one or more non-transitory computer readable media of clause 11, wherein generating the final tree-based model comprises constructing a combination of the first trained decision tree model and the at least the second trained decision tree model.

13. The one or more non-transitory computer readable media of clauses 11 or 12, wherein generating the first trained decision tree model comprises executing the initial model on a plurality of feature vectors included in the training dataset to generate a plurality of predicted outputs; and training a decision tree model to predict a negative gradient of a loss function with respect to the plurality of predicted outputs.

14. The one or more non-transitory computer readable media of any of clauses 11-13, further comprising, while training the decision tree model, determining that a tree depth of the decision tree model is equal to a maximum tree depth; and designating the decision tree model as the first trained decision tree model.

15. The one or more non-transitory computer readable media of any of clauses 11-14, further comprising determining that a total number of trained decision tree models included in the final tree-based model is equal to a maximum number of trees; and designating the final tree-based model as a trained tree-based model.

16. The one or more non-transitory computer readable media of any of clauses 11-15, wherein executing the final tree-based model in conjunction with the first data transmission network comprises causing a first processor included in a network interface card to execute a first instance of the final tree-based model in order to control a transmission rate of a network flow included in the first data transmission network.

17. The one or more non-transitory computer readable media of any of clauses 11-16, wherein executing the final tree-based model in conjunction with the first data transmission network to control congestion comprises computing, via the final tree-based model, a first modification to be made to a network flow included in the first data transmission network based on at least one of a delay measurement, a latency measurement, or a transmission rate of the network flow; and modifying the network flow based on the first modification.

18. The one or more non-transitory computer readable media of any of clauses 11-17, wherein the training dataset includes a mapping from at least one of a delay measurement, a latency measurement, or a transmission rate of a network flow included in the simulated data transmission network to a modification to be made to the transmission rate.

19. The one or more non-transitory computer readable media of any of clauses 11-18, wherein a final loss for the final tree-based model relative to the training dataset is less than the initial loss.

20. In some embodiments, a system comprises one or more memories storing instructions and one or more processors coupled to the one or more memories that, when executing the instructions, perform the steps of executing a first trained neural network in conjunction with a simulated data transmission network to generate a training dataset, wherein the first trained neural network has been trained to control congestion in the simulated data transmission network; generating a first trained decision tree model based on an initial loss for an initial model relative to the training dataset; generating a final tree-based model based on the first trained decision tree model and at least a second trained decision tree model; and executing the final tree-based model in conjunction with a first data transmission network to control congestion within the first data transmission network.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling congestion in data transmission networks, the method comprising:
executing a first trained neural network in conjunction with a simulated data transmission network to generate a training dataset, wherein the first trained neural network has been trained to control congestion in the simulated data transmission network;
generating a first trained decision tree model based on an initial loss for an initial model relative to the training dataset;
generating a final tree-based model based on the first trained decision tree model and at least a second trained decision tree model; and
executing the final tree-based model in conjunction with a first data transmission network to control congestion within the first data transmission network.

2. The computer-implemented method of claim 1, wherein generating the final tree-based model comprises constructing a combination of the first trained decision tree model and the at least the second trained decision tree model.

3. The computer-implemented method of claim 1, wherein generating the first trained decision tree model comprises:
executing the initial model on a plurality of feature vectors included in the training dataset to generate a plurality of predicted outputs; and
training a decision tree model to predict a negative gradient of a loss function with respect to the plurality of predicted outputs.

4. The computer-implemented method of claim 3, further comprising:
while training the decision tree model, determining that a tree depth of the decision tree model is equal to a maximum tree depth; and
designating the decision tree model as the first trained decision tree model.

5. The computer-implemented method of claim 1, further comprising:
determining that a total number of trained decision tree models included in the final tree-based model is equal to a maximum number of trees; and
designating the final tree-based model as a trained tree-based model.

6. The computer-implemented method of claim 1, wherein the first data transmission network comprises a remote direct memory access network.

7. The computer-implemented method of claim 1, wherein executing the final tree-based model in conjunction with the first data transmission network to control congestion comprises:
computing, via the final tree-based model, a first modification to be made to a network flow included in the first data transmission network based on at least one of a delay measurement, a latency measurement, or a transmission rate of the network flow; and
modifying the network flow based on the first modification.

8. The computer-implemented method of claim 1, wherein the training dataset includes a mapping from a first feature vector associated with a network flow included in the simulated data transmission network to a first modification to be made to the network flow.

9. The computer-implemented method of claim 8, further comprising modifying a transmission rate of the network flow in accordance with the first modification.

10. The computer-implemented method of claim 8, wherein the first feature vector comprises at least one of a delay measurement, a latency measurement, or a transmission rate associated with the network flow.

11. One or more non-transitory computer readable media including instructions that, when executed by one or more processors, cause the one or more processors to automatically control congestion in data transmission networks by performing the steps of:
executing a first trained neural network in conjunction with a simulated data transmission network to generate a training dataset, wherein the first trained neural network has been trained to control congestion in the simulated data transmission network;
generating a first trained decision tree model based on an initial loss for an initial model relative to the training dataset;
generating a final tree-based model based on the first trained decision tree model and at least a second trained decision tree model; and
executing the final tree-based model in conjunction with a first data transmission network to control congestion within the first data transmission network.

12. The one or more non-transitory computer readable media of claim 11, wherein generating the final tree-based model comprises constructing a combination of the first trained decision tree model and the at least the second trained decision tree model.

13. The one or more non-transitory computer readable media of claim 11, wherein generating the first trained decision tree model comprises:
executing the initial model on a plurality of feature vectors included in the training dataset to generate a plurality of predicted outputs; and
training a decision tree model to predict a negative gradient of a loss function with respect to the plurality of predicted outputs.

14. The one or more non-transitory computer readable media of claim 13, further comprising:
while training the decision tree model, determining that a tree depth of the decision tree model is equal to a maximum tree depth; and
designating the decision tree model as the first trained decision tree model.

15. The one or more non-transitory computer readable media of claim 11, further comprising:
determining that a total number of trained decision tree models included in the final tree-based model is equal to a maximum number of trees; and
designating the final tree-based model as a trained tree-based model.

16. The one or more non-transitory computer readable media of claim 11, wherein executing the final tree-based model in conjunction with the first data transmission network comprises causing a first processor included in a network interface card to execute a first instance of the final tree-based model in order to control a transmission rate of a network flow included in the first data transmission network.

17. The one or more non-transitory computer readable media of claim 11, wherein executing the final tree-based model in conjunction with the first data transmission network to control congestion comprises:
computing, via the final tree-based model, a first modification to be made to a network flow included in the first data transmission network based on at least one of a delay measurement, a latency measurement, or a transmission rate of the network flow; and
modifying the network flow based on the first modification.

18. The one or more non-transitory computer readable media of claim 11, wherein the training dataset includes a mapping from at least one of a delay measurement, a latency measurement, or a transmission rate of a network flow included in the simulated data transmission network to a modification to be made to the transmission rate.

19. The one or more non-transitory computer readable media of claim 11, wherein a final loss for the final tree-based model relative to the training dataset is less than the initial loss.

20. A system comprising:
one or more memories storing instructions; and
one or more processors coupled to the one or more memories that, when executing the instructions, perform the steps of:
executing a first trained neural network in conjunction with a simulated data transmission network to generate a training dataset, wherein the first trained neural network has been trained to control congestion in the simulated data transmission network;
generating a first trained decision tree model based on an initial loss for an initial model relative to the training dataset;
generating a final tree-based model based on the first trained decision tree model and at least a second trained decision tree model; and
executing the final tree-based model in conjunction with a first data transmission network to control congestion within the first data transmission network.
